(19) United States
(12) Patent Application Publication
(10) Pub. No.: US 2018/0027850 A1
(43) Pub. Date: Feb. 1, 2018

(54) SYSTEMS AND METHODS FOR PREPARING PORK RINDS

(71) Applicants: Luis Alberto Sandor, Los Angeles, CA (US); Victor Manuel Ayala, Seattle, WA (US); Martin Raul Sandor, Los Angeles, CA (US)

(72) Inventors: Luis Alberto Sandor, Los Angeles, CA (US); Victor Manuel Ayala, Seattle, WA (US); Martin Raul Sandor, Los Angeles, CA (US)

(21) Appl. No.: 15/221,597

(22) Filed: Jul. 28, 2016

(51) Int. Cl. A23L 13/20; A23L 5/10; A47J 37/12; A23P 30/10

(52) U.S. Cl. CPC A23L 13/20; A23P 30/10; A23L 5/11; A47J 37/1204; A23V 2002/00

(57) ABSTRACT

Some embodiments are directed to a method for preparing a plurality of pork rinds. The method can include slicing a raw pork skin into a cuboidal shape; slicing the cuboidal-shaped raw pork skin into rectangular-shaped pork skin pieces; placing each of the rectangular-shaped pork skin pieces between two members of a metal mold, wherein each of the members of the metal mold are detachably connected to each other; immersing the metal mold encasing the pork skin pieces into a vat at least partially filled with a cooking medium; heating the cooking medium to a predefined temperature for a predefined time duration to fry the pork skin pieces into pork rinds; removing the pork rinds from the metal mold; and wrapping each of the pork rinds in a package.

### BACKGROUND

The disclosed subject matter relates to systems and methods for preparing food, such as, for example, a crunchy meat snack. More particularly, the disclosed subject matter relates to systems and methods for preparing a pork rind, and systems and methods for preparing a pork rind with a flat shape.

Snacks are a small portion of food, which are eaten between meals such as, a breakfast meal and a lunch meal, or a lunch meal and a dinner meal, and the like. A number of snacks that are available in the market include, but not restricted to, nuts, potato chips, tostadas, popcorns, pies, cakes, and the like. These snacks have a crunchy taste with a variety of characteristics such as, a color, a flavor, a texture, and the like. However, consumers, nowadays are eating junk food instead of healthy snacks. Generally, the junk foods often contain: sugar, starch, flour, potatoes, grains and/or unhealthy fats, etc. that are considered unhealthy food products. Junk foods have low nutritional value and are highly processed food that contains harmful synthetic chemicals. Consumption of these foods can contribute to a number of health problems.

### SUMMARY

Generally, many consumers prefer to eat tostadas as a snack or to combine it with a number of food products. Tostadas may also be eaten as meal (or part of a meal). The standardized, usually round shape of the tostadas allow consumers to place a number of toppings on the surface of the tostadas before consuming as the toppings add flavors to the tostadas as per the consumer's preferred taste. Further, the tostadas provide crunchy and salty taste that combines with the toppings to give a soothing taste to the consumers. However, the tostadas are primarily made from corn, and therefore are rich in carbohydrates.

Over consumption of the food products that are rich in carbohydrates may contribute to metabolic problems, such as, heart diseases, diabetes, and so forth. Therefore, due to the detrimental aspects of carbohydrates in food products, consumers are now following a diet that is substantially lower in carbohydrates. Such a diet is referred to as a low-carb diet. One of the challenges encountered by those eating a low-carb diet is finding a substitute for tostadas, potato chips, corn chips, crackers, and the like.

A food product consumed by consumers in large quantity is pork rind that is also a well-known snack. The pork rind is made up of the skin of a pig. The pork rind can also be known as, but not restricted to, pork scratching, chicharron, or pork crackling. The pork rind can be used, but not restricted to, in sausages to improve its consistency, as a fried or roasted pork rind snack, and so forth. Pork rinds are considered a low-carb food and may be used as an alternative to tostadas, and the like. Also, the pork rinds provide a similar crunchy sensation as the tostadas, potato chips, corn chips and crackers, and the like.

In some related arts, the shapes of pork rinds do not allow consumers to add toppings on the surface of the pork rinds as conveniently as in the case of tostadas. Therefore, the pork rinds lack a standardized shape for adding toppings.

It may therefore be beneficial to provide snacks or food products, that address at least one of the above issues. For example, it may be beneficial to provide food products that have low carbohydrates, provide a substitute of tostadas, and may be considered as a healthy snack.

It may therefore be beneficial to provide systems and methods for preparing low-carb snacks that address at least one of the above issues and/or other disadvantages. In particular, it may be beneficial to provide systems and methods for preparing pork rinds.

It may be beneficial to provide a system and a method for removing excess fat from raw pork skin before preparing pork rinds in order to achieve the discussed thin shape. In particular, it may be beneficial to provide low-carb pork rinds.

It may therefore be beneficial to provide a system and a method for preparing pork rinds having a standardized shape. In particular, it may be beneficial to provide pork rinds with a flat shape to add seasonings and/or toppings on the pork rinds.

It may therefore be beneficial to provide a system and a method for packaging the pork rinds. For example, it may be beneficial to wrap the pork rinds in a package for consumer use.

Some embodiments are therefore directed to a method for preparing a plurality of pork rinds. The method can include slicing a raw pork skin into a cuboidal shape; slicing the cuboidal-shaped raw pork skin into a plurality of rectangular-shaped pork skin pieces, wherein each of the plurality of pork skin pieces has a substantially rectangular shape with a predefined length and a predefined width; placing each of the plurality of rectangular-shaped pork skin pieces between a two members of a metal mold, wherein each of the members of the metal mold are detachably connected to each other; immersing the metal mold encasing the plurality of pork skin pieces into a vat at least partially filled with a cooking medium; heating the cooking medium to a predefined temperature for a predefined time duration to fry the plurality of pork skin pieces into a plurality of pork rinds; removing the plurality of pork rinds from the metal mold; and wrapping each of the plurality of pork rinds in a package.

Some other embodiments are directed to a method for preparing a plurality of pork rinds. The method can include: slicing a raw pork skin into a cuboidal shape; hanging the cuboidal-shaped raw pork skin in a heated room at a predefined temperature to achieve desired moisture content; slicing the cuboidal-shaped raw pork skin into a plurality of rectangular-shaped pork skin pieces, wherein each of the plurality of pork skin pieces has a substantially rectangular shape with a predefined length and a predefined width; placing each of the plurality of rectangular-shaped pork skin pieces between a two members of a metal mold, wherein each of the members of the metal mold are detachably connected to each other; immersing the metal mold encasing the plurality of pork skin pieces into a vat at least partially filled with a cooking medium; heating the cooking medium to a predefined temperature for a predefined time duration to fry the plurality of pork skin pieces into a plurality of pork rinds; removing the plurality of pork rinds from the metal mold; and wrapping each of the plurality of pork rinds in a package.

Yet other embodiments are directed to a system for preparing a plurality of pork rinds. The system can include a cutter that is configured to slice a raw pork skin into a cuboidal shape. The system can also include a hanging assembly that is configured to hang the raw pork skin in a heated room at a predefined temperature to achieve desired moisture content. The system can also include a slicing table that is configured to slice the cuboidal-shaped raw pork skin into a plurality of rectangular-shaped pork skin pieces, wherein each of the plurality of pork skin pieces has a substantially rectangular shape with a predefined length and a predefined width. The system can also include a metal mold that includes two members detachably connected to each other, wherein the two members is configured to receive each of the plurality of rectangular-shaped pork skin pieces there between in a connected state. The system can also include a vat that is configured to at least partially receive the metal mold encasing the plurality of pork skin pieces therein, wherein the vat is at least partially filled with a cooking medium. The system can also include a heating unit that is configured to heat the cooking medium to a predefined temperature for a predefined time duration to fry the plurality of pork skin pieces into a plurality of pork rinds. The system can also include a packing unit that is configured to wrap each of the plurality of pork rinds in a package.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1A is a plan view of a minimum dimension and a maximum dimension of a pork rind in accordance with the disclosed subject matter.

FIG. 1B is a cross-sectional view of a minimum thickness and a maximum thickness of the pork rind in accordance with the disclosed subject matter.

FIG. 1C is a plan view of exemplary shapes of the pork rind in accordance with the disclosed subject matter.

FIG. 2A is a plan view of a slicing table in accordance with the disclosed subject matter.

FIG. 2B is a cross sectional view of the slicing table in accordance with the disclosed subject matter.

FIG. 3 is a side view of a conveyer belt in accordance with the disclosed subject matter.

FIG. 4A is a plan view of a metal mold illustrating casings to hold the pork rinds in accordance with the disclosed subject matter.

FIG. 4B is a cross sectional view of the metal mold in accordance with the disclosed subject matter.

FIG. 5 is a cross sectional view of a vat for frying the pork rinds in accordance with the disclosed subject matter.

FIG. 6A is a front view of a packaging unit to wrap the pork rinds in accordance with the disclosed subject matter.

FIG. 6B is a side view of the packaging unit to wrap the pork rinds in accordance with the disclosed subject matter.

FIG. 7 is a flowchart of a procedure for preparing pork rinds in accordance with the disclosed subject matter.

FIG. 8 is a flowchart of another procedure for preparing pork rinds in accordance with the disclosed subject matter.

FIG. 9 is an electronic system for preparing pork rinds in accordance with the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

### I. System for Preparing Pork Rind

Embodiments of the disclosed subject matter provides a system and a method for preparing pork rinds. More specifically, embodiments of the disclosed subject matter disclose a method for preparing pork rinds that are low in carbohydrates. Also, embodiments of the disclosed subject matter disclose a method for preparing pork rinds that are a substitute of tostadas. More particularly, the pork rinds that are prepared by the embodiments of the disclosed subject matter may be similar to corn-based tostadas. However, the pork rinds of the disclosed subject matter are healthier than the tostadas. Although the use of pork is disclosed herein, it is envisioned that the embodiments include other foods such as, for example, chicken, mutton, beef or the like, without departing from the scope of the invention.

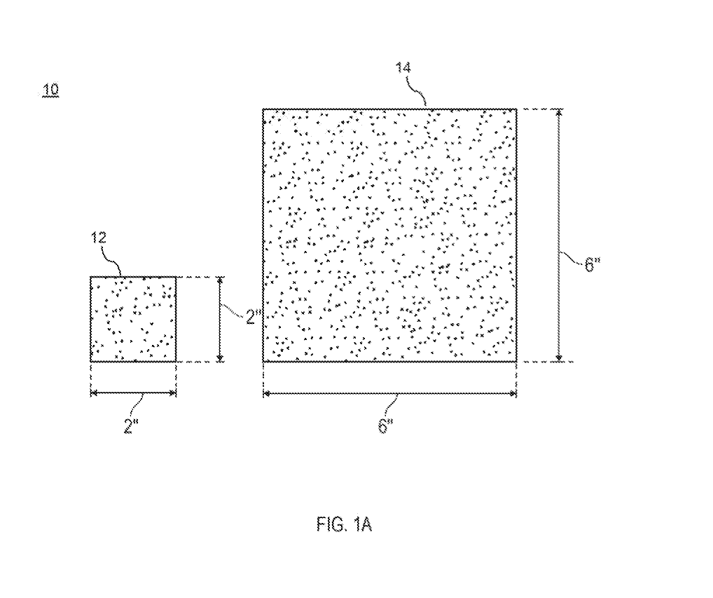

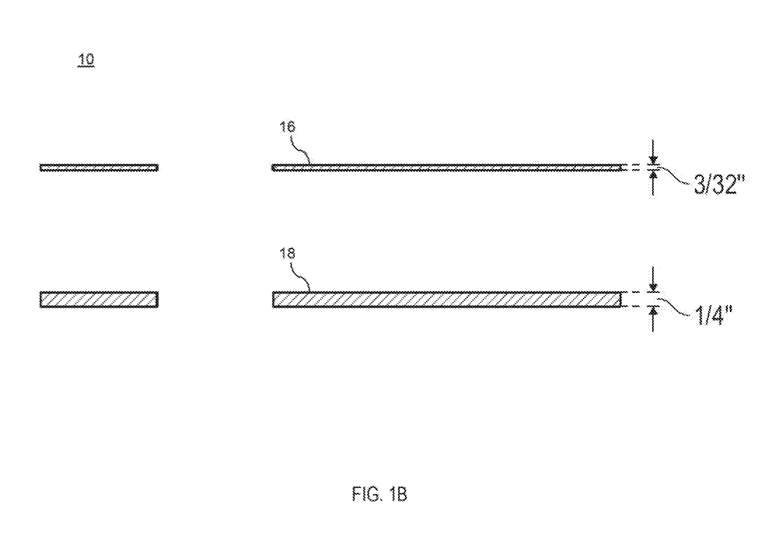

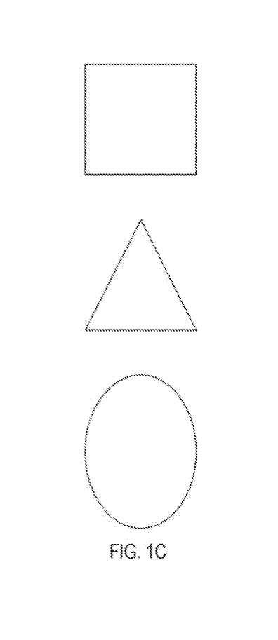

In some embodiments, a system for preparing pork rinds may include a cutter or knife blades for slicing a raw pork skin. In other embodiments, different cuts of pork may be used instead of or in addition to pork skin, such as, for example, pork ribs. As shown in FIG. 1C, the raw pork skin may be sliced into a number of different desired shapes. In some embodiments, the desired shape of the raw pork skin may include, but not restricted to, a cube, a rectangular cuboid, and the like. However, embodiments are intended to include or otherwise cover any shape of the raw pork skin that may be beneficial. For example, the raw pork skin may have a shape similar to potato chips, corn chips, crackers, tostadas, and the like. In some embodiments, the raw pork skin may be sliced into a predefined dimension having a predefined length, width and thickness. The predefined length of the raw pork skin may be in the range of between about two inches and six inches. Also, the predefined width of the raw pork skin may be in the range of between about two inches and six inches. The predefined thickness of the raw pork skin may be in the range of between about 3/32 inch and a maximum of ¼ inch. FIG. 1A illustrates a plan view of minimum and maximum dimensions of a pork rind in accordance with the disclosed subject matter. The minimum dimension 12 that is a length or a width of the raw pork skin may be two inches and the maximum dimension 14 that is a length or a width of the raw pork skin may be six inches.

Further, FIG. 1B illustrates a cross-sectional view of a minimum thickness and a maximum thickness of the pork rind in accordance with the disclosed subject matter. The minimum thickness 16 of the raw pork skin may be 3/32 inch and the maximum thickness 18 of the raw pork skin may be ¼ inch.

In some embodiments, the perimeter of the raw pork skin may be sliced into the desired shape with a surface area in the range of between about two inches squared and six inches squared. As shown in FIG. 1C, the perimeter of the raw pork skin may be sliced into a shape such as, but is not restricted to, a square, a triangle, or an oval. In an exemplary scenario, the square shaped raw pork skin may be a substitute for cracker snacks. In another exemplary scenario, the triangle shaped raw pork skin may be a substitute for corn chips, or an oval shaped raw pork skin may be considered as a substitute for potato chips. However, embodiments are intended to include or otherwise cover any shape of the perimeter of the raw pork skin that may be beneficial.

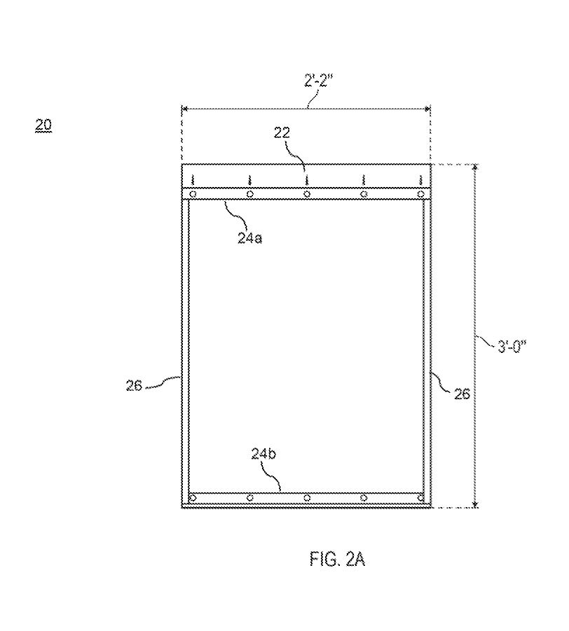

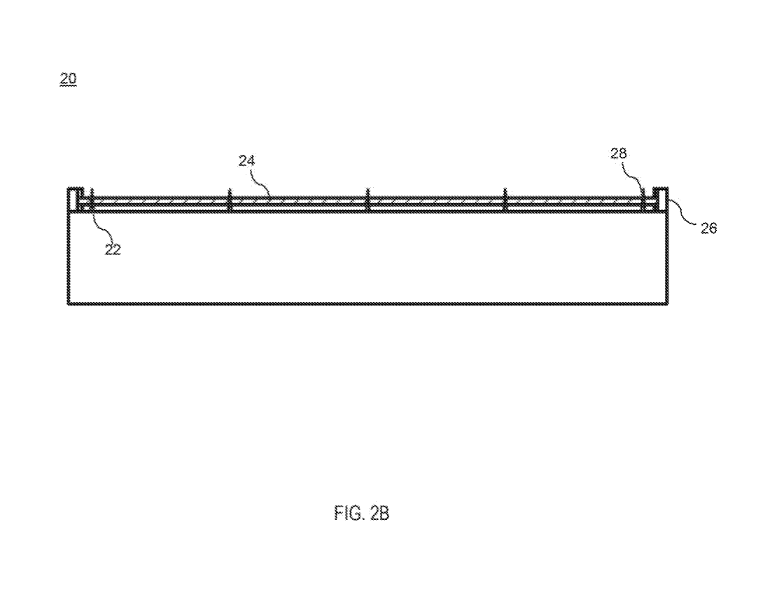

In some embodiments, the cutter or knife blades 22 are attached to a slicing table 20. FIG. 2A is a plan view of the slicing table 20 in accordance with the disclosed subject matter. The slicing table 20 may be used to slice the raw pork skin into a desired width with predefined dimensions. In an exemplary scenario, the length of the slicing table 20 is about three feet two inches and the width of the slicing table 20 is about two feet two inches. The raw pork skin may be placed on a rail 26 of the slicing table 20 as per a skin clamp start position 24a and a skin clamp end position 24b. The skin clamp start position 24a and the skin clamp end position 24b may be indicated by markings on the slicing table 20. The slicing table 20 may include knife blades 22 that may be one inch in width.

FIG. 2B is a cross sectional view of the slicing table in accordance with the disclosed subject matter. A top clamp 24, that is located at the skin clamp start position 24a, may be used to clamp the raw pork skin by using one or more pins 28 attached with the rail 26. The one or more pins 28 may secure the raw pork skin to the slicing table 20. The raw pork skin may then be sliced into the desired width in the range of between about two inches and six inches.

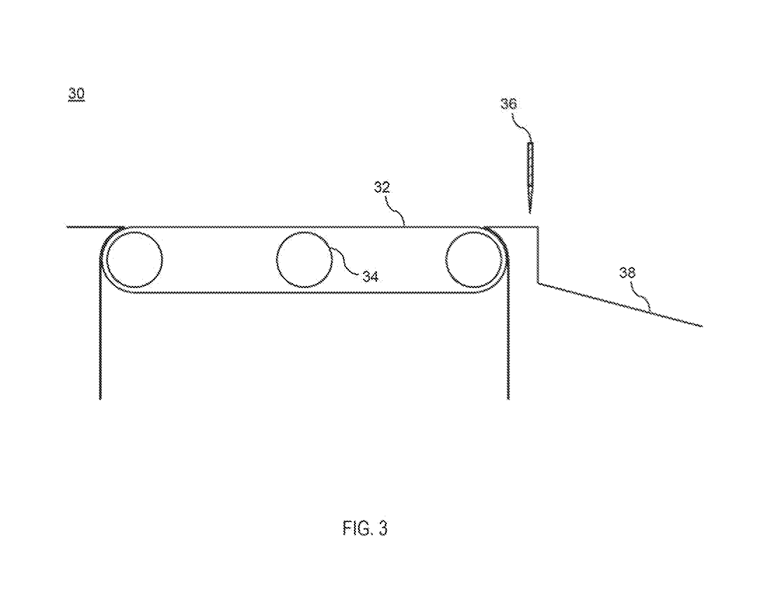

Further, the raw pork skin may be placed on a conveyer 30 to slice the raw pork skin in a predefined or desired length. FIG. 3 is a side view of the conveyer 30 in accordance with the disclosed subject matter. The raw pork skin, after being sliced into the desired width, is placed on the conveyer 30 in order to slice it into a predefined length. The conveyer 30 includes a conveyer belt 32 that moves in a direction to move the raw pork skin by using pulleys 34. The raw pork skin may be forwarded to a chopping blade 36 to chop and/or slice the raw pork skin into the predefined length. The raw pork skin may be sliced into the predefined length in the range of between about two inches and six inches. In an exemplary embodiment, the raw pork skin may be sliced having a length of about four inches. After slicing the raw pork skin into the predefined length, the raw pork skin pieces are collected in a catch tray 38.

Further, in some embodiments, seasonings are added to the collected raw pork skin pieces in the catch tray 38. The seasonings may include, but not restricted to, edible salt, black pepper, red chili, colorant, smoke, preservatives (e.g., sodium phosphates), spices, and the like, or a combination thereof. However, embodiments of the disclosed subject matter are intended to include, or otherwise cover any type of seasonings that may be beneficial to add flavor, texture, color, and the like to the raw pork skin pieces. The seasonings may be dry, and/or wet in order to add flavor to the raw pork skin pieces.

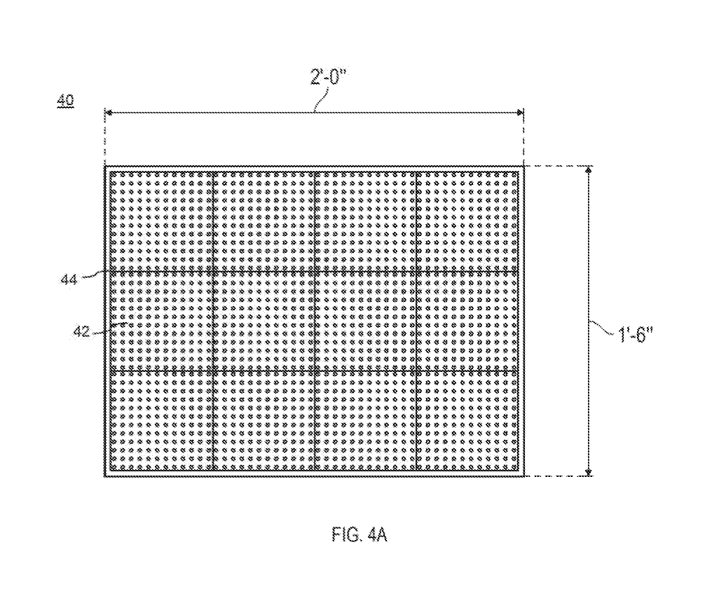

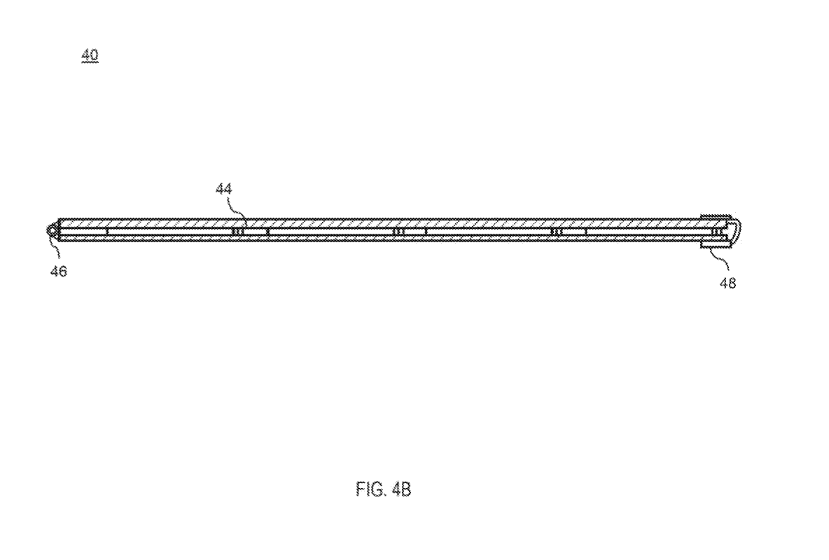

In some embodiments, the raw pork skin pieces may be placed into a metal mold 40. FIG. 4A is a plan view of the metal mold 40 illustrating a casing of two members to hold the pork rinds in accordance with the disclosed subject matter. The metal mold 40 may be, but not restricted to, a stainless steel mold, an aluminum mold, and the like. However, embodiments of the disclosed subject matter are intended to include and/or otherwise cover any metal mold that may be beneficial. In some embodiments, the metal mold 40 may be one foot six inches in length and 2 feet in width. The metal mold 40 may include two members (not shown) to hold the raw pork skin pieces between them. The two members of the metal mold 40 are detachably connected to each other. In some embodiments, the spacing between the two members of the metal mold 40 may be between the range of about 1/16 inch to about ½ inch in order to accommodate expansion of the pork skin pieces.

In some embodiments, the metal mold 40 may have sections 42 such that each of the sections 42 hold a raw pork skin piece. The metal mold 40 is divided into multiple sections 42 by a divider 44. In an exemplary embodiment, the metal mold 40 is divided into 12 equal sections having a width in the range of between about 1/16 inch to about ½ inch. In alternate embodiments, the metal mold 40 may be divided into 10 equal sections. However, embodiments of the disclosed subject matter are intended to include, or otherwise cover any number of sections that may be beneficial to hold the raw pork skin pieces.

After placing the raw pork skin pieces into the sections of the metal mold 40, the two members of the metal mold 40 are locked through a hinge 46 and a locking mechanism 48, as shown in FIG. 4B. In an exemplary embodiment, the locking mechanism 48 may be a hydraulic cylinder that may be used to close the metal mold 40.

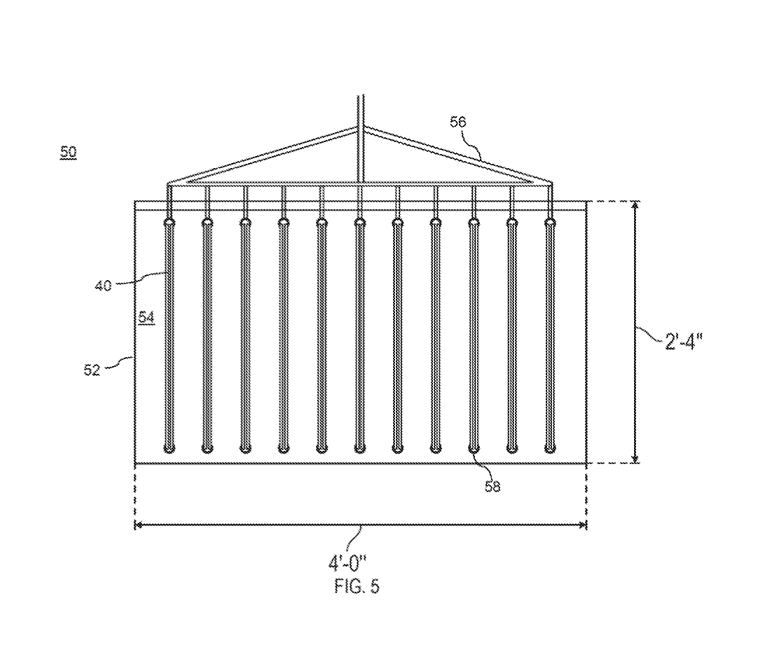

The system further includes a heating unit for frying the pork rinds. FIG. 5 illustrates a cross sectional view of the heating unit 50 for frying the raw pork skin pieces in accordance with the disclosed subject matter. In some embodiments, the heating unit 50 includes a vat 52 that is at least partially filled with a cooking medium 54. In some embodiments, the vat 52 may have width in the range of between about four feet and six feet. The height of the vat 52 may be in the range of between about two feet four inches and three feet. However, embodiments of the disclosed subject matter may be intended to include and/or cover any dimensions of the vat 52 that may be beneficial to fry the raw pork skin pieces. Further, the dimensions of the vat 52 may be such that the vat 52 can at least partially receive one or more of the metal molds 40 therein.

In some embodiments, the cooking medium 54 may be, but not restricted to, pork lard. The smoke point of the pork lard is between the range of about 250 to 424 degrees Fahrenheit (° F.). In alternate embodiments, the cooking medium 54 may be, but not restricted to, oil that may be beneficial to fry the raw pork skin pieces. However, embodiments of the disclosed subject matter may intend to include and/or cover any type of cooking medium that may be beneficial to fry the raw pork skin pieces.

The heating unit 50 may also include a hanger 56 having multiple clamp molds 58 that may be configured to secure the metal molds 40 and submerge the metal molds 40 into the cooking medium 54. The metal molds 40 may be submerged into the vat 52 containing the cooking medium 54 that is heated to a predefined temperature, and predefined temperature maintained for a predetermined time duration. In some embodiments, the predefined temperature of the cooking medium 54 is between the range of about 300 to 400 degrees Fahrenheit (° F.). In some embodiments, the predefined time duration for frying the raw pork skin pieces may be between the range of about 10 seconds to 30 seconds. The raw pork skin pieces are fried till the time desired moisture content and texture is achieved. When the raw pork skin pieces are fried in the vat 52 partially filled with the cooking medium 54, the raw pork skin pieces become pork rinds.

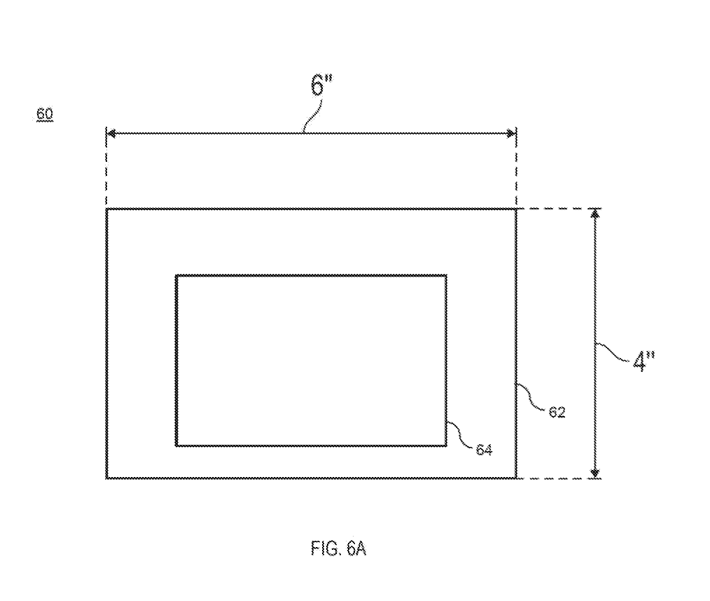

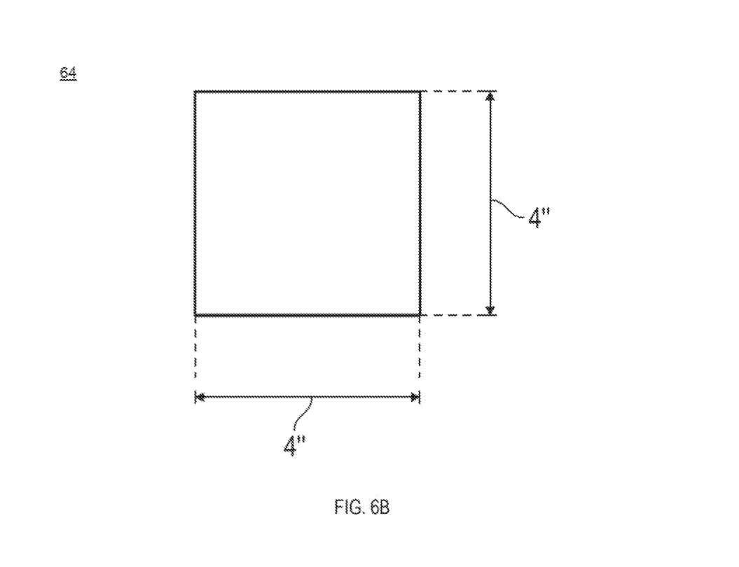

Further, the system includes a packaging unit 60 for wrapping the pork rinds in packages. FIG. 6A is a front view of the packaging unit 60 to wrap the pork rinds in accordance with the disclosed subject matter. In some embodiments, the packaging unit 60 may include a brown cardboard 62 as an outer package for the pork rinds. The width of the brown cardboard 62 may be in the range of between about six inches to eight inches. The length of the brown cardboard 62 may be in the range of between about four inches to six inches. The dimensions of the brown cardboard 62 used in the packaging unit 60 are for exemplary purpose only. FIG. 6B is a side view of the packaging unit 60 to wrap the pork rinds in accordance with the disclosed subject matter. Each of the length and width of the packaging unit 60 may be in the range of between about four inches to six inches. However, embodiments of the disclosed subject matter are intended to include and/or cover any dimensions of the packaging that may be beneficial to wrap the pork rind.

Also, a clear acetate film 64 may be used on the package to view the pork rinds. Each of the length and width of the acetate film 64 may be in the range of between about four inches to six inches. The dimensions of the acetate film 64 used in the packaging unit 60 are for exemplary purpose only. However, embodiments of the disclosed subject matter are intended to include and/or cover any dimension of the packaging that may be beneficial for viewing of the pork rind.

The package of the pork rinds is such that the moisture and crunchiness of the pork rinds remains intact resulting in a longer shelf life. The brown cardboard 62 and the acetate film 64 used in the packaging unit 60 are for exemplary purpose only. However, embodiments of the disclosed subject matter are intended to include and/or cover any type of packaging material that may be beneficial to wrap the pork rinds.

### II. Method for Preparing Pork Rinds

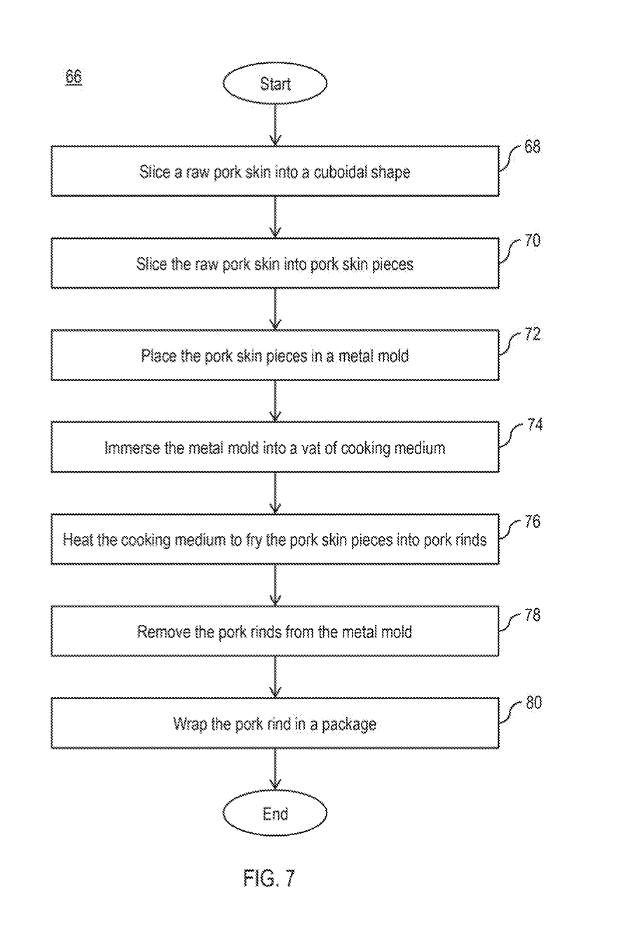

FIG. 7 is a flowchart of a procedure 66 for preparing pork rinds in accordance with the disclosed subject matter. This flowchart is merely provided for exemplary purposes, and embodiments are intended to include or otherwise cover any methods or procedures for preparing pork rinds.

In accordance with the flowchart of FIG. 7, at step 68, a raw pork skin is sliced into a desired shape. The desired shape of the raw pork skin may include, but not restricted to, a cube, a rectangle, and the like. In an exemplary embodiment, the raw pork skin may be sliced into a cuboidal shape. However, embodiments are intended to include or otherwise cover any shape of the raw pork skin that may be beneficial. In some embodiments, the raw pork skin may be sliced into predefined dimensions having a predefined length, width and thickness. The predefined length of the raw pork skin may be in the range of between about two inches and six inches. Also, the predefined width of the raw pork skin may be in the range of between about two inches and six inches. The predefined thickness of the raw pork skin may be in the range of between about 3/32 inch and maximum of ¼ inch. In some embodiments, fat from the raw pork skin is removed until the predefined thickness in the range of between about 3/32 inch and maximum of ¼ inch is achieved. Embodiments are intended to include or otherwise cover any techniques, including known, related art, and/or later developed technologies to slice the raw pork skin.

In some embodiments, the perimeter of the raw pork skin may be sliced into the desired shape with a surface area in the range of between about two inches squared and six inches squared.

Further, in some embodiments, the raw pork skin may be sliced into a flat shaped pork skin. The flat shape of the raw pork skin may hold various toppings.

Further, the flat-shaped raw pork skin may be hung in a heated environment to achieve the desired moisture content. In some embodiments, the desired moisture content of the raw pork skin may be in the range between about 5% to 20% by weight. However, embodiments of the disclosed subject matter may intend to include and/or otherwise cover any weight of moisture content that may be beneficial.

Next, at step 70, the raw pork skin is sliced into pork skin pieces with desired dimensions. In the above exemplary embodiment, the cuboidal shaped raw pork skin is sliced into the pork skin pieces. In some embodiments, each of the pork skin pieces has a substantially rectangular shape with a predefined length and a predefined width. The predefined length of each of the pork skin pieces may be in the range between about six inches and the predefined width of each of the pork skin pieces may be in the range between about six inches.

Further, seasonings may be added to each of the pork skin pieces to add flavor, texture, color, and the like or a combination thereof. The seasonings may include, but not restricted to, edible salt, black pepper, red chili, colorant, smoke, preservatives (e.g., sodium phosphates), spices, and the like, or combination thereof. However, embodiments of the disclosed subject matter are intended to include, or otherwise cover any type of seasonings that may be beneficial. The seasonings may be dry, and/or wet in order to add flavor to the raw pork skin pieces.

Next, at step 72, the pork skin pieces are placed in a metal mold, such as the metal mold 40. As discussed above, the metal mold may be, but not restricted to, a stainless steel mold, an aluminum mold, and the like. The metal mold may include two members between which the pork skin pieces are placed. The members of the metal mold 40 are detachably connected to each other.

At step 74, the metal mold is immersed in a vat that is filled with a cooking medium. In some embodiments, the vat is partially filled with the cooking medium. The cooking medium may be, but not restricted to, pork lard. The smoke point of the pork lard is between the range of about 250 to 424 degree Fahrenheit (° F.). In alternate embodiments, the cooking medium may be, but not restricted to, oil that may be beneficial to fry the pork rinds. However, embodiments of the disclosed subject matter may intend to include and/or cover any type of cooking medium that may be beneficial to fry the raw pork skin pieces.

Thereafter at step 76, the cooking medium is heated to a predefined temperature for a predefined time duration. In some embodiments, the predefined temperature of the cooking medium is between the range of about 300 to 400 degree Fahrenheit (° F.). In some embodiments, the predefined time duration for frying the raw pork skin pieces may be between the range of about 10 seconds to 30 seconds. The raw pork skin pieces are fried till the time desired moisture content and texture is achieved. When the raw pork skin pieces are fried in the vat partially filled with the cooking medium, the raw pork skin pieces become pork rinds.

Further, the pork rinds are removed from the metal mold, at step 78. The pork rinds are then wrapped in a package, at step 80, for consumer use. In some embodiments, the pork rinds may be wrapped in an acetate film to view the pork rinds and in a brown cardboard.

### III. Alternate Method for Preparing Pork Rinds

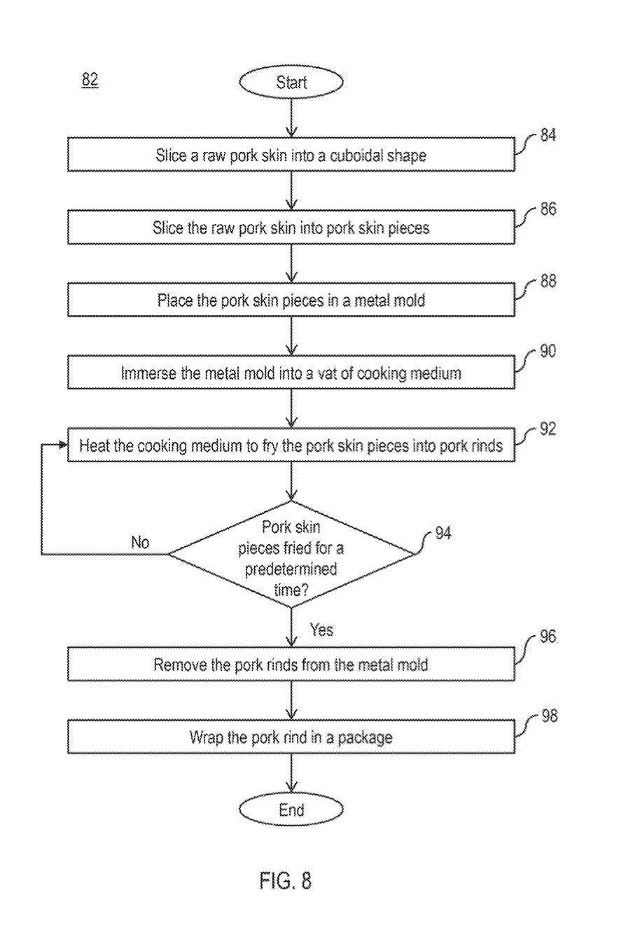

FIG. 8 is a flowchart of an alternate procedure 82 for preparing pork rinds in accordance with the disclosed subject matter. This flowchart is merely provided for exemplary purposes, and embodiments are intended to include or otherwise cover any methods or procedures for preparing pork rinds.

In accordance with the flowchart of FIG. 8, at step 84, a raw pork skin is sliced into a desired shape. The desired shape of the raw pork skin may include, but not restricted to, a cube, a rectangle, and the like. In an exemplary embodiment, the raw pork skin may be sliced into a cuboidal shape. However, embodiments are intended to include or otherwise cover any shape of the raw pork skin that may be beneficial. In some embodiments, the raw pork skin may be sliced into a predefined dimension having a predefined length, width and thickness. The predefined length of the raw pork skin may be in the range of between about two inches and six inches. Also, the predefined width of the raw pork skin may be in the range of between about two inches and six inches. The predefined thickness of the raw pork skin may be in the range of between about 3/32 inch and maximum of ¼ inch. In some embodiments, fat from the raw pork skin is removed until the desired thickness in the range of between about 3/32 inch and maximum of ¼ inch is achieved. Embodiments are intended to include or otherwise cover any techniques, including known, related art, and/or later developed technologies to slice the raw pork skin.

Further, in some embodiments, the raw pork skin may be sliced into a flat shaped pork skin. The flat shape of the raw pork skin may hold various toppings.

Further, the flat-shaped raw pork skin may be hung in a heated environment to achieve the desired moisture content. In some embodiments, the desired moisture content of the raw pork skin may be in the range between about 5% to 20% by weight of the pork skin. However, embodiments of the disclosed subject matter may intend to include and/or otherwise cover any weight of moisture content that may be beneficial.

Next, at step 86, the raw pork skin is sliced into pork skin pieces with desired dimensions. In the above exemplary embodiment, the cuboidal shaped raw pork skin is sliced into the pork skin pieces. In some embodiments, each of the pork skin pieces has a substantially rectangular shape with a predefined length and a predefined width. The predefined length of each of the pork skin pieces may be in the range between about 2 inches and 6 inches and the predefined width of each of the pork skin pieces may be in the range between about 2 inches and 6 inches.

Further, seasonings may be added to each of the pork skin pieces to add flavor, texture, color, and the like, or a combination thereof. The seasonings may include, but not restricted to, edible salt, black pepper, red chili, colorant, smoke, preservatives (e.g., sodium phosphates), spices, and the like, or a combination thereof. However, embodiments of the disclosed subject matter are intended to include, or otherwise cover any type of seasonings that may be beneficial. The seasonings may be dry, and/or wet in order to add flavor to the raw pork skin pieces.

Next, at step 88, the pork skin pieces are placed in a metal mold, such as the metal mold 40. As discussed above, the metal mold may be, but not restricted to, a stainless steel mold, an aluminum mold, and the like. The metal mold may include two members between which the pork skin pieces are placed. The members of the metal mold 40 are detachably connected to each other.

At step 90, the metal mold is immersed in a vat that is filled with a cooking medium. In some embodiments, the vat is at least partially filled with the cooking medium. The cooking medium may be, but not restricted to, pork lard. The smoke point of the pork lard is between the range of about 300 to 400 degrees Fahrenheit (° F.). In alternate embodiments, the cooking medium may be, but not restricted to, oil that may be beneficial to fry the pork rinds. However, embodiments of the disclosed subject matter may intend to include and/or cover any type of cooking medium that may be beneficial to fry the raw pork skin pieces.

Thereafter at step 92, the cooking medium is heated to a predefined temperature, and the predefined temperature is maintained for a predefined time duration. In some embodiments, the predefined temperature of the cooking medium is between the range of about 300 to 400 degrees Fahrenheit (° F.). In some embodiments, the predefined time duration for frying the raw pork skin pieces may be between the range of about 10 seconds to 30 seconds. The raw pork skin pieces are fried till the time desired moisture content and texture is achieved. When the raw pork skin pieces are fried in the vat partially filled with the cooking medium, the raw pork skin pieces become pork rinds.

Next, at step 94, it is determined whether the pork skin pieces are fried for a predetermined time duration. In case, the pork skin pieces are not fried to the predefined time duration, then the process 82 returns to step 92. In case, the pork skin pieces are not fried for the predefined time duration, then the process 82 proceeds to step 96.

At step 96, the pork rinds are removed from the metal mold. Embodiments of the disclosed subject matter are intended to include or otherwise cover any techniques, including known, related art, and/or later developed technologies to remove the pork rinds from the metal mold. In addition, in some embodiments, one or more seasonings may be added to the pork rinds. The seasonings may include, but not restricted to, oregano, yeast, paprika, sugar, vinegar powder, and the like. However, embodiments of the disclosed subject matter may be intended to include and/or cover any type of seasonings that may be beneficial to add texture, flavor, color, and the like.

At step 98, the pork rinds are wrapped in a package. In some embodiments, the pork rinds may be wrapped in a brown cardboard with an acetate film to allow a consumer to view the pork rinds in packaged state. However, embodiments of the disclosed subject matter may be intended to include and/or cover any type of packaging material that may be beneficial to increase shelf life and retain moisture content in the pork rinds.

### IV. Computer System for Preparing Pork Rinds

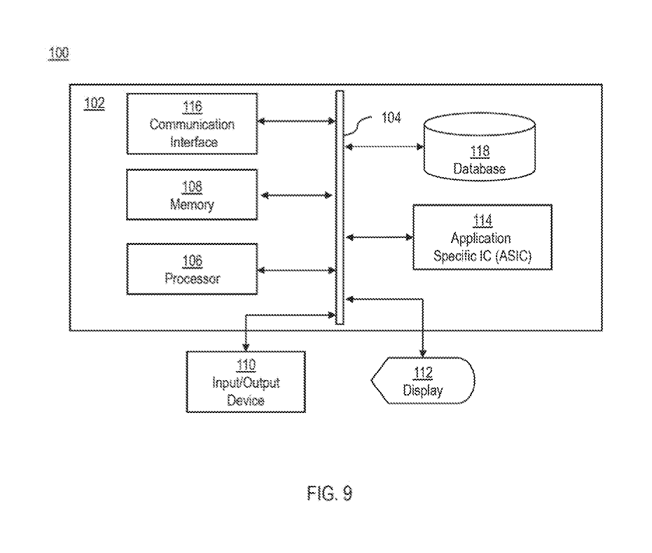

FIG. 9 illustrates an exemplary electronic system 100 upon which some embodiment of the disclosed subject matter can be implemented. In fact, embodiments of the disclosed subject matter are intended to include or otherwise cover any type of electronic system, including known, related art, and/or later developed technologies. The electronic system 100 includes an electronic device 102 that can be programmed, for example, via computer program code or instructions to prepare pork rinds described in the disclosed subject matter. The electronic device 102 can include a communication mechanism such as a bus 104 to pass data between internal and external components of the electronic system 100. The data can be represented as a physical expression of a measurable phenomenon, typically electric voltages, but can include, in some certain embodiments, such phenomena as magnetic, electromagnetic, pressure, chemical, biological, molecular, atomic, sub-atomic and quantum interactions. The electronic system 100, or a portion thereof, constitutes a means for performing one or more steps for preparing pork rinds.

The bus 104 can include one or more parallel conductors of data so that the data can be transferred quickly among communication devices coupled to the bus 104. In some embodiments, a processor 106 is coupled with the bus 104 for processing the data. However, one processor 106 shown in FIG. 9 is for illustration purpose only. However, some alternate embodiments of the disclosed subject matter can include more than one processor.

The processor 106 can perform a set of instructions on the data as specified by computer program code related to prepare the pork rinds. In an exemplary embodiment, the processor 106 may execute instructions for determining predefined temperature and/or predefined time duration for every stage for preparing the pork rinds. In some embodiments, the processor 106 can be implemented as mechanical, electrical, magnetic, optical, chemical, or quantum components, among others, alone or in combination.

The electronic device 102 can also include a memory 108. In certain embodiments, the memory 108 can be coupled to the bus 104. In some embodiments, the memory 108 can be, but not restricted to, a Random Access Memory (RAM), a Read only Memory (ROM) or any other dynamic or static storage device, stores information including processor instructions for storing data and instructions to be executed by the processor 106. In some embodiments, the memory 108 can include a volatile storage that can lose the data and instructions stored thereon when power is lost. In alternate embodiments, the memory 108 can include a non-volatile (persistent) storage device, such as a magnetic disk, a solid state disk, optical disk or flash card, for storing data, including instructions, that persists even when the electronic device 102 is turned off or otherwise loses power.

The electronic system 100 can include an external input/output device 110, such as a keyboard including alphanumeric keys operated by a human user, a microphone, a mouse, a joystick, a game pad, a stylus pen, a touch screen, a sensor, etc. for providing the predefined temperature and time duration to the bus 104. In some embodiments, external devices can be coupled to the bus 104, can be used primarily for interacting with users, can include a display 112. In certain embodiments, the display 112 can be, but not restricted to, a Cathode Ray Tube (CRT), a Liquid Crystal Display (LCD), a Light Emitting Diode (LED) display, an organic LED (OLED) display, an active matrix display, an Electrophoretic Display (EPD), a plasma screen, etc. Further, in some embodiments, the display 112 can be a touch-enabled display such as a capacitive screen or a resistive screen for providing the instructions to the electronic device 102.

In some embodiments, special purpose hardware, such as an Application Specific Integrated Circuit (ASIC) 114 can be coupled to the bus 104. The ASIC 114 can be configured to perform operations that cannot be performed by the processor 106 quickly enough for special purposes.

The electronic device 102 can also include a communication interface 116 coupled to the bus 104. The communication interface 116 can provide a one-way or two-way communication coupling to a variety of external devices, such as, but not restricted to, choppers, conveyers, and the like. Embodiments are intended to include or otherwise cover any type of communication interface, including known, related art, and/or later developed technologies.

The electronic device 102 may also include a database 118 for storing the data. In some other embodiments, the database 118 can be used to store predefined parameters such as, but not restricted to, temperature, time duration, required moisture content, and the like. Embodiments are intended to include or otherwise cover any type of database, including known, related art, and/or later developed technologies. However, some alternate embodiments of the disclosed subject matter can employ more than one database 84.

### V. Alternative Embodiments

While certain embodiments of the invention are described above, and FIGS. 1-9 disclose the best mode for practicing the various inventive aspects, it should be understood that the invention can be embodied and configured in many different ways without departing from the spirit and scope of the invention.

Embodiments are disclosed above in the context of pork rinds. However, embodiments are intended to cover methods and systems for preparing the pork rinds.

Embodiments are also intended to include or otherwise cover methods of preparing pork rinds disclosed above. The systems and methods for preparing pork rinds include or otherwise cover processors and computer programs implemented by processors used to process raw pork skins disclosed above.

Embodiments are also intended to include or otherwise cover methods of preparing low-carb pork rinds disclosed above. Embodiments further include systems and methods for preparing low-carb pork rinds that are considered as a healthy snack.

Embodiments are also intended to include or otherwise cover methods of preparing pork rinds disclosed above. Embodiments further include systems and methods for preparing flat-shaped pork rinds with added seasonings.

Embodiments are also intended to include or otherwise cover methods of preparing pork rinds disclosed above. The systems and methods for preparing flat-shaped pork rinds include or otherwise cover processors and computer programs implemented by processors used to process the flat-shaped pork rinds disclosed above.

Exemplary embodiments are intended to cover all software or computer programs capable of enabling processors to implement the above operations, designs and determinations. Exemplary embodiments are also intended to cover any and all currently known, related art or later developed non-transitory recording or storage mediums that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations of preparing pork rinds disclosed above.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

What is claimed is:

1. A method for preparing food, the method comprising:
slicing a raw cut of animal protein or fat into a first shape;
slicing the first-shaped raw cut of animal protein or fat into a plurality of pieces, wherein each of the plurality of pieces has a second shape with a predefined length and a predefined width;
placing each of the plurality of pieces between two members of a metal mold, wherein each of the members of the metal mold are detachably connected to each other;
immersing the metal mold encasing the plurality of pieces into a vat at least partially filled with a cooking medium;
heating the cooking medium to a predefined temperature for a predefined time duration to cook the plurality of pieces;
removing the cooked pieces from the metal mold; and
wrapping the cooked pieces in a package.

2. The method of claim 1, wherein
the food is a plurality of pork rinds,
the raw cut of animal protein or fat is a raw cut of pork skin,
the cooking medium fries the pork skin,
the first shape is cuboidal, and
the second shape is substantially rectangular.

3. The method of claim 2, further comprising removing excess fat from the raw pork skin.

4. The method of claim 2, wherein the raw pork skin is sliced into a plurality of flat raw pork pieces having a substantially uniform thickness sufficient to support dipping each of the plurality of pork rinds into another food product or supporting additional food product without substantially losing the second shape of the pork rinds.

5. The method of claim 2, further comprising hanging the raw pork skin in a heated room at a predefined temperature to achieve desired moisture content.

6. The method of claim 2, further comprising adding seasonings onto the plurality of rectangular-shaped pork skin pieces.

7. The method of claim 2, wherein the cooking medium is at least one of cooking oil, or pork lard.

8. The method of claim 2, further comprising removing the members of the metal mold from the vat of at least partially filled cooking medium.

9. The method of claim 2, wherein each of the plurality of sliced pork skin pieces is about ¼ inch to 3/32 inch in thickness.

10. The method of claim 2, wherein the predefined width and the predefined length of each of the plurality of sliced pork skin pieces is about 2 inches to 6 inches.

11. A method for preparing a plurality of pork rinds, the method comprising:
slicing a raw pork skin into a cuboidal shape;
hanging the cuboidal-shaped raw pork skin in a heated room at a predefined temperature to achieve desired moisture content;
slicing the cuboidal-shaped raw pork skin into a plurality of rectangular-shaped pork skin pieces, wherein each of the plurality of pork skin pieces has a substantially rectangular shape with a predefined length and a predefined width;
placing each of the plurality of rectangular-shaped pork skin pieces between a two members of a metal mold, wherein each of the members of the metal mold are detachably connected to each other;
immersing the metal mold encasing the plurality of pork skin pieces into a vat at least partially filled with a cooking medium;
heating the cooking medium to a predefined temperature for a predefined time duration to fry the plurality of pork skin pieces into a plurality of pork rinds;
removing the plurality of pork rinds from the metal mold; and
wrapping each of the plurality of pork rinds in a package.

12. The method of claim 11, further comprising removing excess fat from the raw pork skin.

13. The method of claim 11, wherein the raw pork skin is sliced into a plurality of flat rectangular-shaped raw pork pieces having a substantially uniform thickness sufficient to support dipping each of the plurality of pork rinds into another food product or supporting additional food product without substantially losing the second shape of the pork rinds.

14. The method of claim 11, further comprising adding seasonings onto the plurality of rectangular-shaped pork skin pieces.

15. The method of claim 11, wherein the cooking medium is at least one of cooking oil, or pork lard.

16. The method of claim 11, further comprising removing the members of the metal mold from the vat of at least partially filled cooking medium.

17. A system for preparing food, the system comprising:
a cutter that is configured to slice a raw cut of animal protein or fat into a first shape;
a hanging assembly that is configured to hang the cut of animal protein or fat in a heated room at a predefined temperature to achieve desired moisture content;
a slicing table that is configured to slice the first shape of the raw cut of animal protein or fat into a plurality of second shaped pieces, wherein each of the pieces has a predefined length and a predefined width;
a metal mold comprising two members detachably connected to each other, wherein the two members are configured to receive each of the plurality of pieces there between in a connected state;
a vat that is configured to at least partially receive the metal mold encasing the plurality of pieces therein, wherein the vat is at least partially filled with a cooking medium;
a heating unit that is configured to heat the cooking medium to a predefined temperature for a predefined time duration to cook the pieces; and
a packing unit that is configured to wrap the cooked pieces in a package.

18. The system of claim 17, wherein
the food is a plurality of pork rinds,
the raw cut of animal protein or fat is a raw cut of pork skin,
the cooking medium fries the pork skin,
the first shape is cuboidal, and
the second shape is substantially rectangular.

19. The system of claim 18, wherein the slicing table comprises at least two clamps that are configured to hold the raw pork skin to slice the raw pork skin into the cuboidal shape.

20. The system of claim 18, further comprising a conveyer belt that is configured to place the cuboidal-shaped raw pork skin for slicing into the plurality of rectangular-shaped pork skin pieces with the predefined length and the predefined width, wherein the plurality of flat raw pork pieces have a substantially uniform thickness sufficient to support dipping each of the plurality of pork rinds into another food product or supporting additional food product without substantially losing the second shape of the pork rinds.
